(19) United States
(12) Patent Application Publication
(10) Pub. No.: US 2004/0194146 A1
(43) Pub. Date: Sep. 30, 2004

(54) Set top box and methods for using the same

(76) Inventors: Cary Lee Bates, Rochester, MN (US); Paul Reuben Day, Rochester, MN (US); Jeffrey Michael Ryan, Byron, MN (US); John Matthew Santosuosso, Rochester, MN (US)

Correspondence Address: DUGAN & DUGAN, P.C., 55 SOUTH BROADWAY, TARRYTOWN, NY, 10591, US

(21) Appl. No.: 10/816,705

(22) Filed: Apr. 2, 2004

Related U.S. Application Data
(62) Division of application No. 09/503,888, filed on Feb. 15, 2000, now abandoned.

(51) Int. Cl. H04N 7/173

(52) U.S. Cl. 725/110; 725/106; 725/109

(57) ABSTRACT

Devices, computer program products, and methods are provided which extend the features of a set top box. In a first aspect, a method is provided for employing a set top box to notify at least one person of a television event. In accordance with the method, a start time of a television event is determined, and a set top box is employed to notify at least one person via a telephone line when a current time is within a predetermined time of the start time. In a second aspect, a method is provided for employing a set top box to record a telephone message. In accordance with the method, a telephone message received via a telephone line coupled to a set top box is recorded by employing the set top box, and at least an indicator of the recorded telephone message is displayed. In a third aspect, a method is provided for controlling a set top box via a telephone line coupled to the set top box. In accordance with the method, a telephone call is received from a calling party via a telephone line coupled to a set top box, and the set top box is controlled via at least one command transmitted by the calling party to the set top box during the telephone call. In other aspects, devices and computer program products are provided that can perform the above described methods.

This application is a division of U.S. patent application Ser. No. 09/503,888, filed Feb. 15, 2000, which is hereby incorporated by reference herein in its entirety.

### FIELD OF THE INVENTION

The present invention relates generally to television systems, and more particularly to an improved set top box and methods for using the same.

### BACKGROUND OF THE INVENTION

Television systems such as digital satellite boxes, digital cable boxes and other similar “set top boxes” are becoming increasingly popular due to the wide variety of television programming that can be easily accessed via these devices. While many set top boxes now offer extensive features related to television programming selection (e.g., user-selectable programming guides, extensive pay-per-view programming, etc.), few offer features beyond those directly related to television programming selection.

### SUMMARY OF THE INVENTION

To address the needs of the prior art, devices, computer program products, and methods are provided which significantly extend the features of a set top box. Specifically, novel set top box features are provided which utilize or otherwise affect one or more telephone lines coupled to a set top box.

In a first aspect of the invention, a method is provided for employing a set top box to notify at least one person of a television event. In accordance with the method, a start time of a television event is determined, and a set top box is employed to notify at least one person via a telephone line when a current time is within a predetermined time of the start time (e.g., when the television event begins, five minutes before the television event begins, five minutes after the television event begins, etc.).

In a second aspect of the invention, a method is provided for employing a set top box to record a telephone message. In accordance with the method, a telephone message received via a telephone line coupled to a set top box is recorded by employing the set top box, and at least an indicator of the recorded telephone message is displayed (e.g., on the set top box, on a television screen, etc.).

In a third aspect of the invention, a method is provided for controlling a set top box via a telephone line coupled to the set top box. In accordance with the method, a telephone call is received from a calling party via a telephone line coupled to a set top box, and the set top box is controlled via at least one command transmitted by the calling party to the set top box during the telephone call.

In other aspects of the invention, devices and computer program products are provided that can perform the above described methods. Each inventive computer program product is carried by a medium readable by a computer (e.g., a carrier wave signal, a floppy disc, a hard drive, a random access memory, etc.).

Other objects, features and advantages of the present invention will become more fully apparent from the following detailed description of the preferred embodiments, the appended claims and the accompanying drawings.

### BRIEF DESCRIPTION OF THE DRAWINGS

FIG. 1 is a schematic diagram of a novel television system configured in accordance with the present invention;

FIG. 2 is a schematic diagram of the novel set top box of FIG. 1;

FIG. 3 is a flowchart of a process for notifying a person of a television event via the novel set top box of FIG. 2;

FIG. 4 is an exemplary list of user-selectable television events displayed by the novel set top box of FIG. 2;

FIG. 5 is a flowchart of a process which, in conjunction with the process of FIG. 3, notifies a person of a television event via the novel set top box of FIG. 2;

FIG. 6 is a flowchart of a process for preventing a room phone coupled to the novel set top box of FIG. 2 from ringing in response to a telephone call;

FIG. 7 is a flowchart of a process for allowing a room phone coupled to the novel set top box of FIG. 2 to ring following the process of FIG. 6;

FIG. 8 is a flowchart of a process for recording a telephone message via the novel set top box of FIG. 2;

FIG. 9 is a flowchart of a process for disabling a television set from displaying television events until a priority message recorded in the process of FIG. 8 has been reviewed;

FIG. 10 is a flowchart of a process for disabling a television set from displaying television events when the novel set top box of FIG. 2 is powered on and unreviewed priority messages are stored by the set top box;

FIG. 11 is a flowchart of a process that provides a menu of user selectable options for selecting, listening to, and deleting telephone messages recorded via the novel set top box of FIG. 2;

FIG. 12 is a flowchart of a process for controlling the novel set top box of FIG. 2 via a telephone; and

FIG. 13 is a flowchart of a process for disabling and enabling the novel set top box of FIG. 2 in conjunction with the process of FIG. 12.

### DETAILED DESCRIPTION OF THE PREFERRED EMBODIMENTS

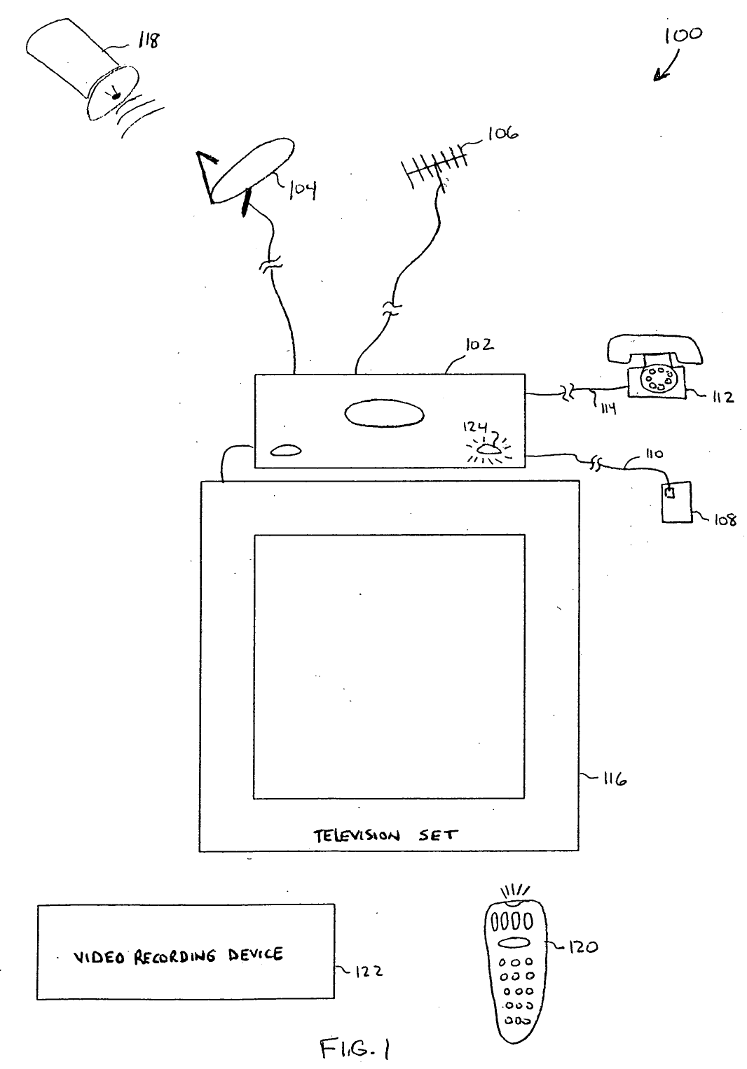

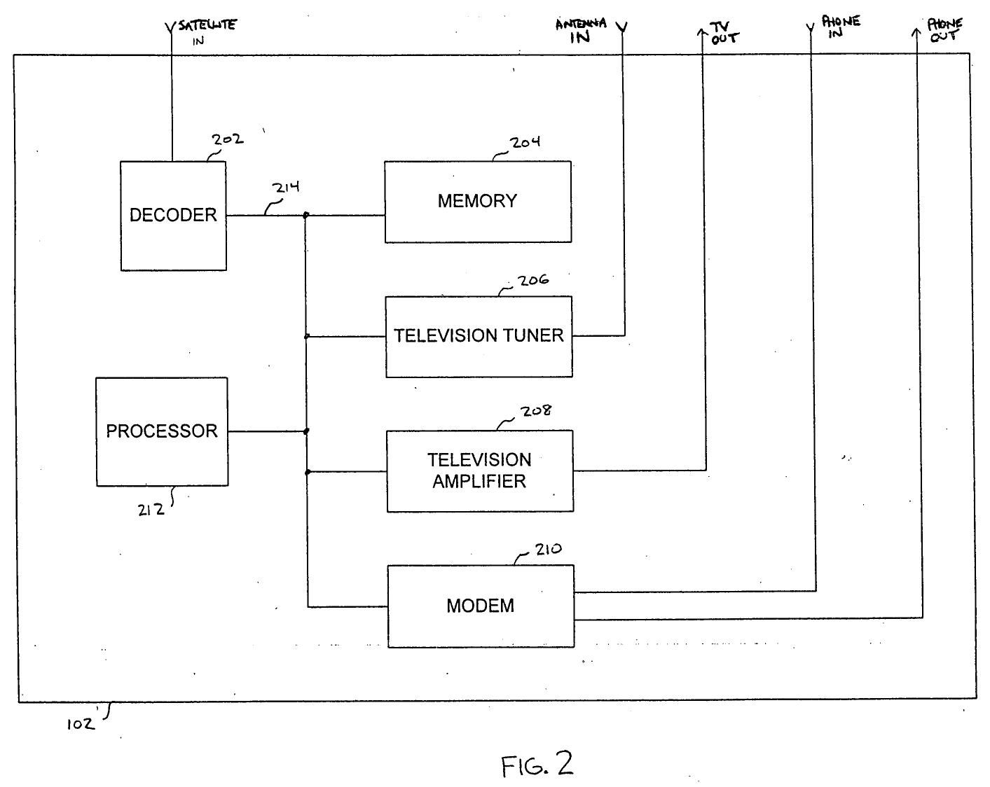

FIG. 1 is a schematic diagram of a novel television system 100 configured in accordance with the present invention. With reference to FIG. 1, the novel television system 100 comprises a novel set top box 102 coupled to a satellite dish 104, to an antenna 106, to a phone jack 108 (e.g., via a phone line 110), to a room phone 112 (e.g., via a phone cord 114) and to a television set 116.

The novel set top box 102 may be based on any conventional set top box such as a satellite-based set top box (shown in FIG. 1) or a cable-based set top box that displays television network programs, movies, sporting events, cable programs, educational programs, pay-per-view events or any other similar television programs (i.e., television events) on a television set. With reference to FIG. 1, the novel set top box 102 is a satellite-based set top box that receives television events via a satellite 118, and may be based, for example, on a Philips Magnavox Model No. 420SY. The novel features of the set top box 102 are described further below with reference to FIGS. 2-13.

The satellite dish 104 may comprise any known satellite dish employable by a conventional set top box to receive television events transmitted from a satellite (e.g., the satellite 118), and the antenna 106 may comprise any known antenna employable by a conventional set top box to receive locally transmitted television events. The room phone 112 may comprise any conventional telephone, the television set 116 may comprise any conventional television set and the phone jack 108 may comprise any telephone interface.

FIG. 2 is a schematic diagram of the novel set top box 102 of FIG. 1. The novel set top box 102 comprises a decoder 202, a memory 204, a television tuner 206, a television amplifier 208, a modem 210 and a processor 212 all coupled via a bus 214. The decoder 202 may comprise any conventional decoding mechanism for receiving a satellite signal from the satellite dish 104 and decoding the satellite signal into discretely viewable television events (e.g., “tuning” to a television set). The memory 204 may comprise any conventional storage mechanism such as a RAM, a flash memory device, a hard disk, a CD-ROM , etc., and the television tuner 206 may comprise any conventional television tuner for tuning to a locally broadcasted television event.

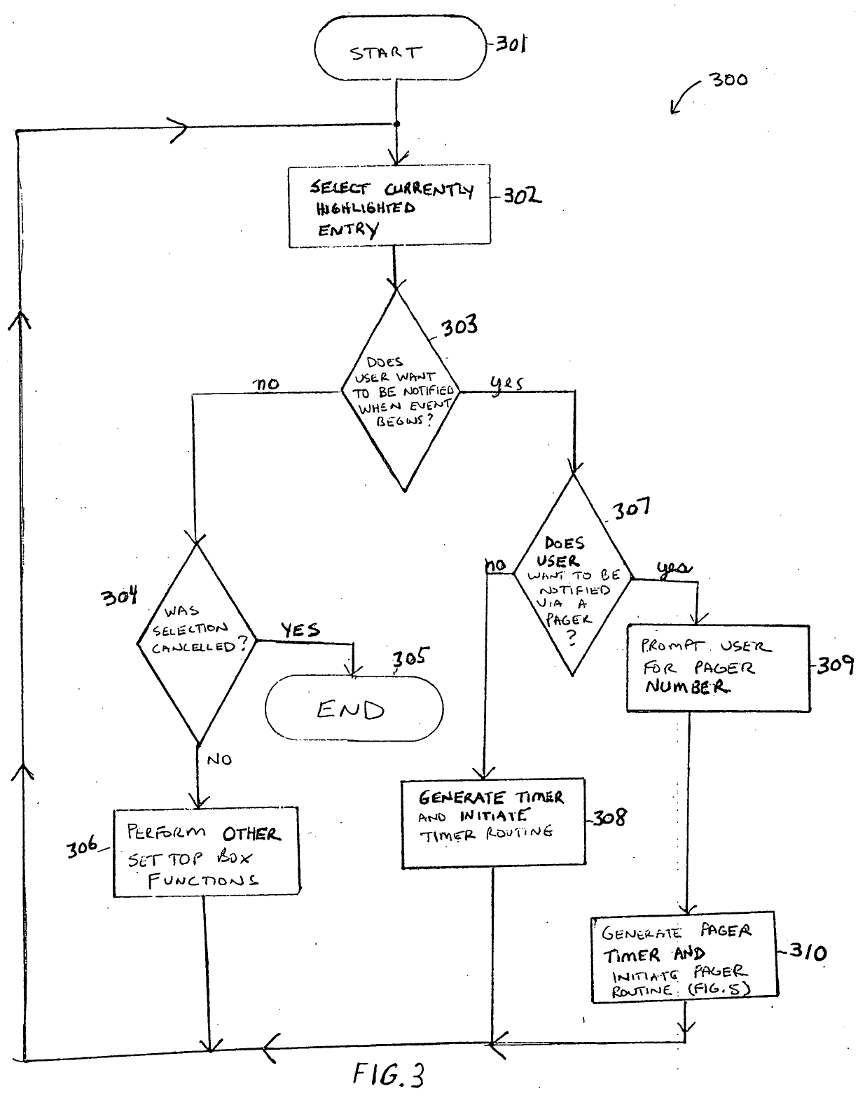

The modem 210 preferably comprises a modem having both a “line in” for receiving telephone calls and/or for dialing out via the phone line 110 and a “line out” for affecting the operation of the room phone 112 via the phone cord 114 as described further below. The processor 212 may comprise any conventional microprocessor or microcontroller that is controllable by computer program code for carrying out the present invention, preferably in accordance with processes 300-1300 described below with reference to FIGS. 3-13. Each process 300-1300 may be embodied in computer program code as a computer program product and may be stored, for example, in the memory 204.

In general, the set top box 102 can perform numerous novel functions. For example, the set top box 102 can (1) notify a person via the phone line 110 when a television event is about to begin; (2) receive and play telephone messages; (3) display an indicator on the television set 116 when a telephone message has been received; (4) play received telephone messages over a speaker of the television 116; (5) be disabled until a received telephone message has been played; (6) play a greeting message to a calling party that states that a user of the novel television system 100 is unavailable until after a television event ends; and (7) be controlled remotely via the phone line 110. These and other novel features and functions of the set top box 102 are described below with reference to FIGS. 3-13.

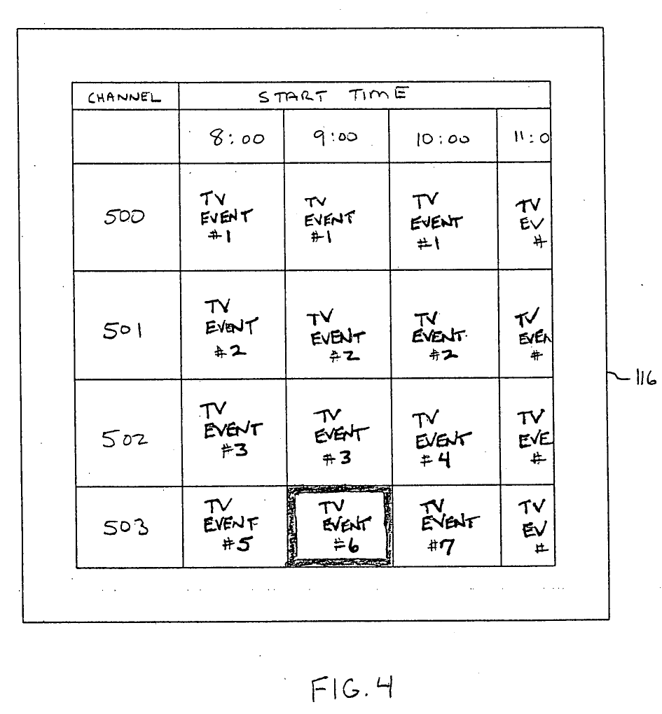

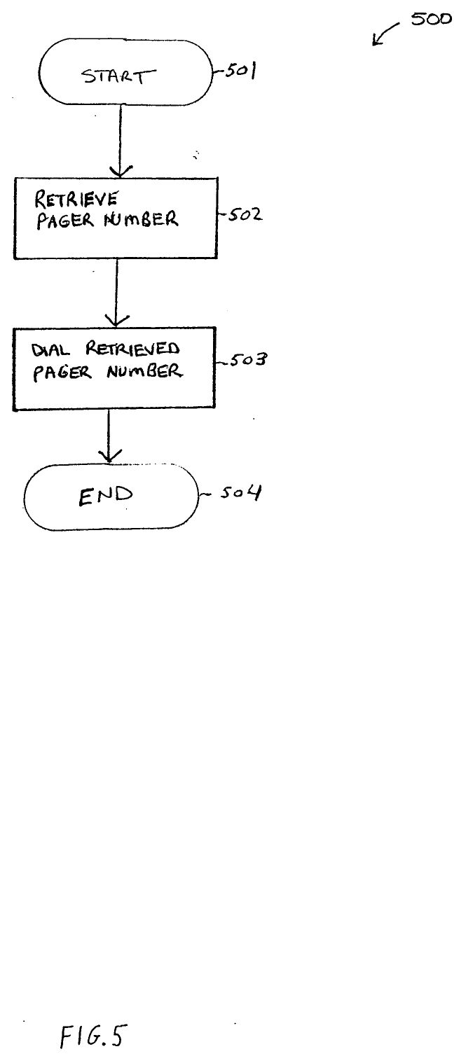

FIG. 3 is a flowchart of a process 300 for notifying a person of a television event via the novel set top box 102. Prior to beginning the process 300, the novel set top box 102 displays a list of user-selectable television events on the television set 116, such as the list of user-selectable television events shown in FIG. 4 (e.g., a list arranged by television channel and start time). To initiate the process 300, a user of the novel television system 100 (herein after “user”) must select a television event that is to occur in the future, rather than a television event that is already in progress. With reference to FIG. 3, the process 300 begins with step 301. In step 302, the novel set top box 102 receives the user's selection of a television event. The user preferably employs a remote control 120 (FIG. 1) to highlight and select a desired television event as shown in FIG. 4 with reference to television event 6. However, any other method for selecting a television event may be employed. Assuming the user has selected a future television event, in step 303, the novel set top box 102 determines if the user wants to be notified when the selected television event is about to begin. For example, the novel set top box 102 may prompt the user with a question “Would you like to be notified that the television event is about to begin?”, the displayed list of user-selectable television events may include start time reminder options, or the remote control 120 may include a start time reminder button that communicates to the novel set top box 102 the user's desire to be notified when the selected television event is about to begin. Any other methods may be employed by the novel set top box 102 to communicate the user's desire to be notified that the selected television event is about to begin.

Preferably, the novel set top box 102 notifies a user that a selected television event is about to begin by generating a “count down” timer based on the start time of a selected television event and the time the user selected the television event. When the timer has “counted down” to zero, the novel set top box 102 notifies the user that the selected television event is about to begin. The novel set top box 102 may notify the user by many different techniques including sounding an alarm over the television set 116, automatically displaying the selected television event, etc. In accordance with the present invention, the novel set top box 102 notifies the user of the selected television event by employing the phone line 110 as described below (e.g., to dial a pager, a cell phone, a telephone, etc.).

While the process 300 preferably notifies a user at the start of the selected television event, it will be understood that a user also may be notified at any predetermined time before or after the start time of the selected television event (e.g., 5 minutes before, 10 minutes after, etc.) and the user preferably may set the predetermined time. In general, the novel set top box 102 may notify the user when a current time is within a predetermined time of television event's start time (e.g., by comparing the start time to the current time and notifying the user when the current time is within the predetermined time of start time).

If in step 303 the novel set top box 102 determines that the user does not want to be notified of the selected television event, the process 300 proceeds with steps 304-306; otherwise, if the user wants to be notified of the selected television event, the process proceeds with steps 307-310.

In step 304 the novel set top box 102 determines if the user has canceled the user's previous selection of a television event (step 302). A television event's selection may be canceled, for example, if the user presses a “cancel” button on the remote 120. If the user has canceled a previous television event selection, in step 305 the process 300 ends; otherwise, in step 306 the novel set top box 102 performs other set top box functions (e.g., retrieve television event information, tune to a television event, etc.) and thereafter returns to step 302 to obtain the user's selection of another television event.

Assuming the user wants to be notified of the television event selected in step 302, in step 307 the novel set top box 102 determines if the user wants to be notified via a pager or via another method (e.g., sounding an alarm over the television set 116). If the user wants to be notified by a method other than via a pager, in step 308, the novel set top box 102 generates a timer and initiates a timer routine that will notify the user of the selected television event by some other method (e.g., by sounding an alarm over the television set 116); otherwise, the process 300 proceeds with step 309.

In step 309, the novel set top box 102 prompts the user for a pager number. One or more pager numbers preferably are stored by the novel set top box 102 (e.g., in the memory 204) so that the user need merely select, verify or change a pager number in step 309. Thereafter, in step 310, the novel set top box 102 generates a timer that “counts down” to the time the selected television event starts. Once the timer counts down to the selected television event's start time, the process 300 proceeds to process 500 described below with reference to FIG. 5. However, until the timer counts down to the selected television event's start time, the process 300 repeats itself, starting with step 302.

FIG. 5 is a flowchart of a process 500 which, in conjunction with the process 300 of FIG. 3, notifies a person of a television event via the novel set top box 102. With reference to FIG. 5, after the timer (generated in step 310 of FIG. 3) counts down to zero, the process 300 proceeds to step 501 of process 500 wherein the process 500 begins.

In step 502, the novel set top box 102 retrieves (e.g., from the memory 204) the pager number obtained, changed or verified previously in step 309 of process 300. Thereafter, in step 503, the novel set top box 102 dials the retrieved pager number via the modem 210 and the phone line 110 so as to notify the user that the television event selected in step 302 of process 300 is about to begin. In step 504, the process 500 ends.

Accordingly, with the processes 300 and 500 of FIGS. 3 and 5, a user can select a television event to be viewed in the future and have the novel set top box 102 notify the user via a pager when the selected television event is about to begin. Preferably the user may specify any predetermined time before or after the selected television event begins to be notified. The user may be notified by any other method that employs the phone line 110 (e.g., via a cellular phone, via a regular telephone, via e-mail, etc.).

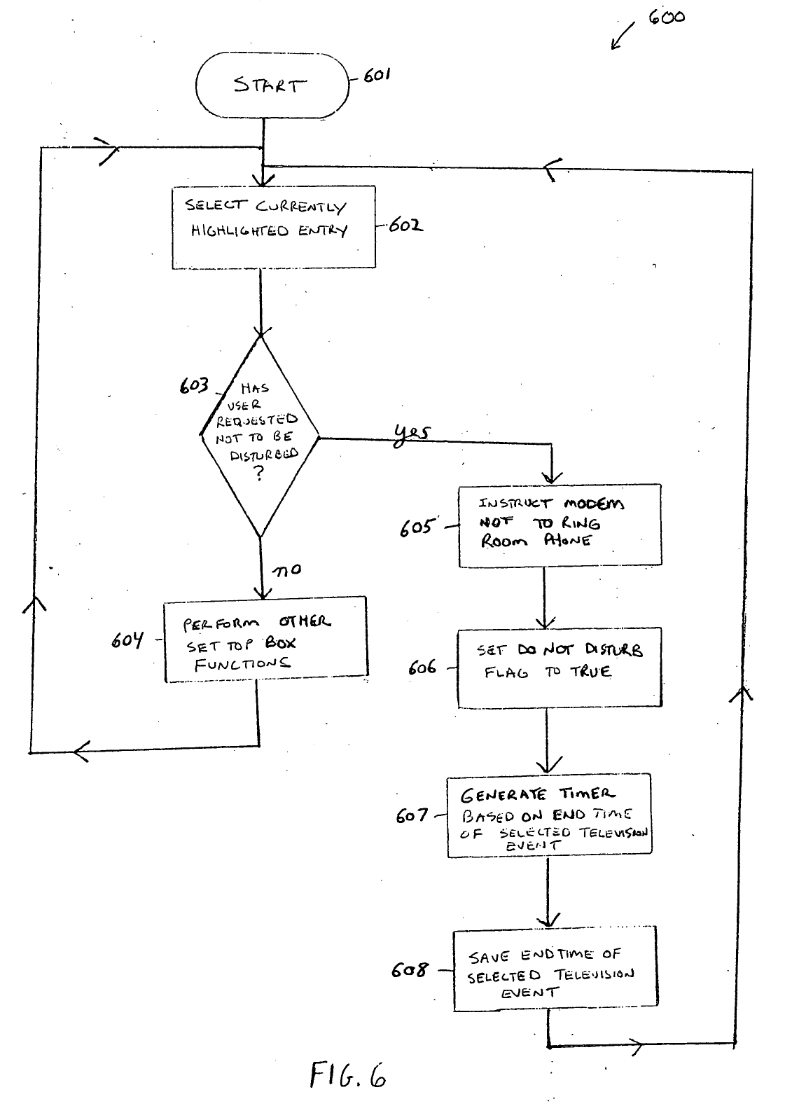

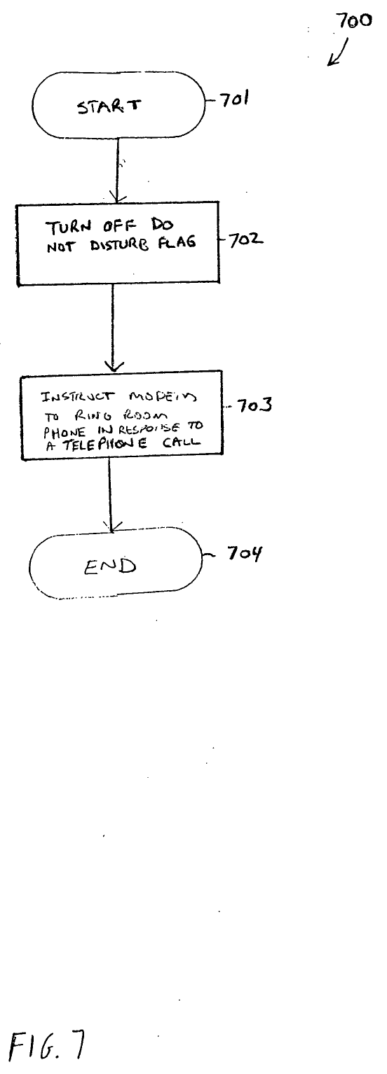

FIG. 6 is a flowchart of a process 600 for preventing the room phone 112 (coupled to the novel set top box 102) from ringing in response to a telephone call on the phone line 110. Prior to beginning process 600, the novel set top box 102 displays a list of user-selectable television events on the television set 116 as described earlier. To initiate the process 600, a user of the novel television system 100 can select a television event that is already in progress or a television event that is to occur in the future.

With reference to FIG. 6, the process 600 begins with step 601. In step 602, the novel set top box 102 receives a selection of a television event by a user of the novel television system 100. Thereafter, in step 603, the novel set top box 102 determines if the user has requested not to be disturbed during the selected television event. For example, the novel set top box 102 may prompt the user with a question, “Would you like the room phone's ring to be disabled while watching the television event?” Alternatively, the displayed list of user-selectable television events may include a “do not disturb” option. Any other method may be employed by the novel set top box 102 to communicate the user's desire to not be disturbed during the selected television event.

If in step 603 the novel set top box 102 determines that the user may want to be disturbed during the television event, the process 600 proceeds with step 604 (e.g., to perform other set top box functions and thereafter to return to step 602 to obtain the user's selection of another television event). Otherwise, if the user does not want to be disturbed during the selected television event, the process 600 proceeds with steps 605-608.

Assuming the user does not want to be disturbed during the television event selected in step 602, in step 605, the processor 212 of the novel set top box 102 sends the modem 210 a command which directs the modem 210 not to ring the room phone 112 if a telephone call is received on phone line 110. In step 606, a “do not disturb (DND)” flag is set (e.g., to true) by the processor 212 to indicate that the user does not want to be disturbed. Note that the order of steps 605 and 606 may be reversed.

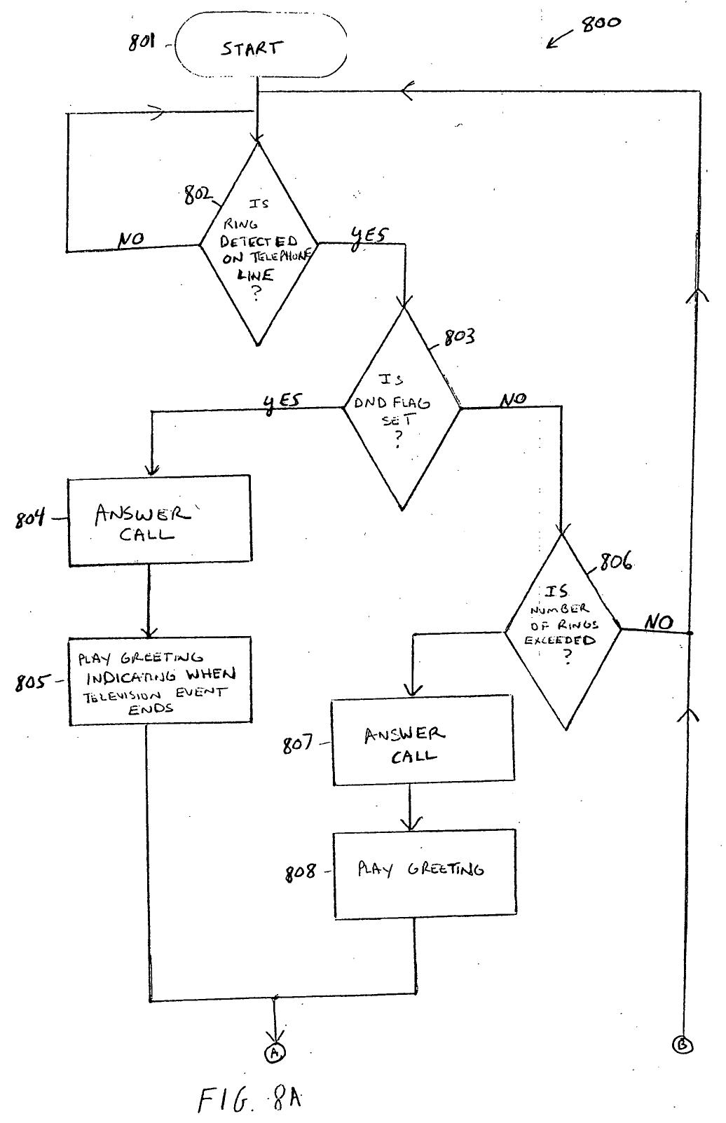

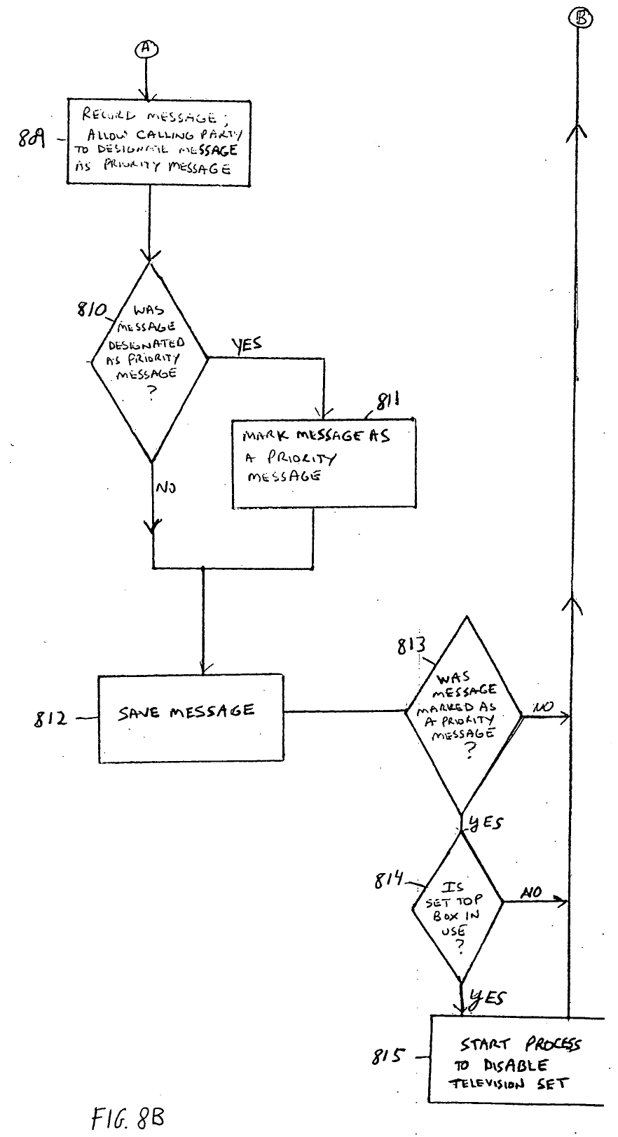

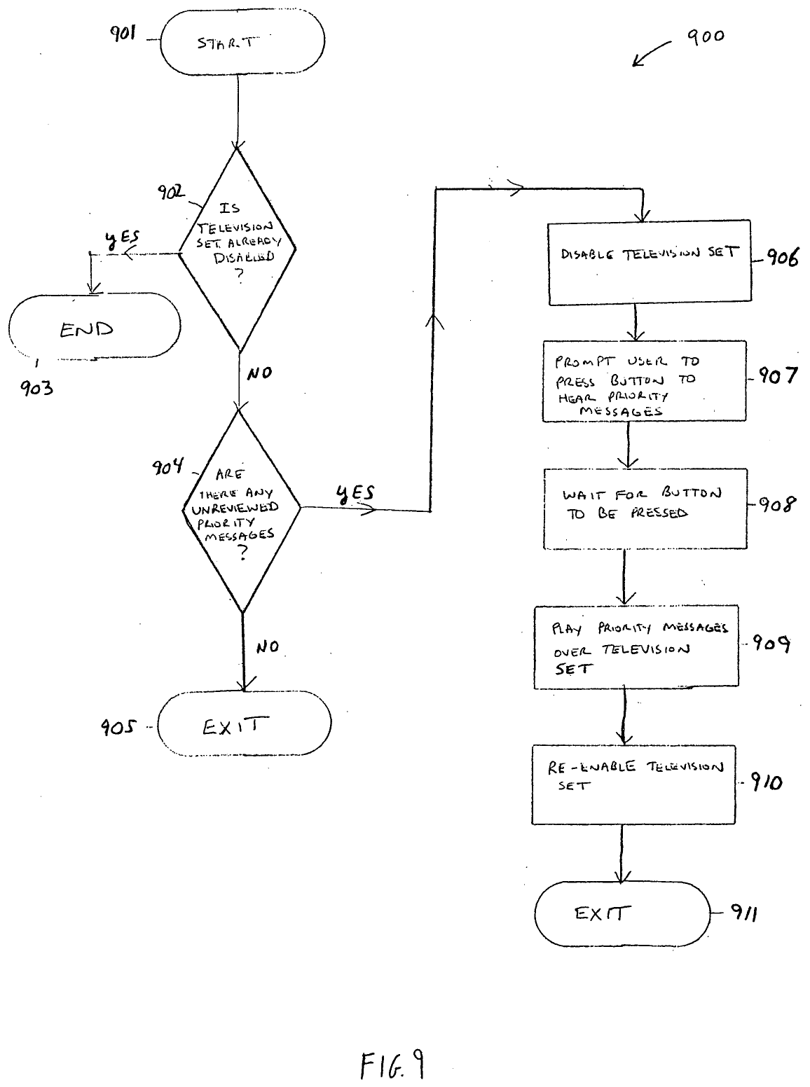

In step 607, the processor 212 generates a timer based on the end time of the selected television event and either the time the user selected the television event, or the start time of the selected television event. In other words, the timer times the entire length of time the user watches the selected television event. In step 608, the processor 212 of the novel set top box 102 saves (e.g., in the memory 204) the end time of the selected television event (for a later use as described below with references to FIG. 8).

Once the timer counts down to zero (e.g., indicating the selected television event has ended), process 600 proceeds with process 700 described below with reference to FIG. 7. Until the timer reaches zero, the process 600 repeats itself, starting with step 602.

FIG. 7 is a flow chart of a process 700 for allowing the room phone 112 (coupled to the novel set top box 102) to ring following the process 600 of FIG. 6. With reference to FIGS. 6 and 7, after the timer generated in step 607 counts down to zero, the process 600 proceeds to step 701 of process 700 wherein the process 700 begins.

In step 702, the DND flag (set by the processor 212 in step 606 of process 600) is turned off (e.g., is set to false). Thereafter, in step 703, the processor 212 directs the modem 210 to ring the room phone 112 in response to a telephone call on the phone line 110. In step 704, the process 700 ends.

Accordingly, with the processes 600 and 700 of FIGS. 6 and 7, a user can prevent the room phone 112 coupled to the novel set top box 102 from ringing in response to a telephone call on the phone line 110. This feature is particularly useful when the user deems a television event important or otherwise “non-disturbable” (i.e., a priority television event). Note that the ring of the room phone 112 alternatively may be delayed rather than disabled so that the room phone 112 rings only if a call on the phone line 110 has not been answered via a telephone other than the room phone 112 (e.g., a telephone in another room). For example, a user of the novel set top box 102 may be provided with the option of delaying the ring of the room phone 112 via any of the methods previously described (e.g., via a prompt from the set top box 102 or via some other selectable option). Once the delayed ring option is selected, the processor 212 preferably prevents the modem 210 from ringing the room phone 112 until a predetermined number of rings is detected on the telephone line 110. The number of rings preferably is user selectable.

FIG. 8 is a flowchart of a process 800 for recording a telephone message via the novel set top box 102. With reference to FIG. 8, the process 800 begins with step 801. In step 802, the processor 212 of the novel set top box 102 detects (via the modem 210) whether the room phone 112 is ringing in response to a telephone call (e.g., from a calling party). More specifically, the processor 212 monitors the first telephone line 110 to determine if a call is present thereon. If a call is not detected on the first telephone line 110, the processor 212 continues to monitor the first telephone line 110.

Once the modem 210 detects a call on the first telephone line 110, in step 803, the processor 212 determines if the DND flag has been set (e.g., if a priority television event is being viewed by a user of the novel television system 100).. If the DND flag is set (e.g., in step 606 of process 600), the process 800 proceeds with steps 804-805. Otherwise, if the DND flag is not set the process 800 proceeds with steps 806-808.

In step 804, the novel set top box 102 answers the telephone call on the phone line 110 (e.g., via the modem 210). Thereafter, in step 805, the processor 212 plays a message (via the modem 210) over the first telephone line 110 to the calling party. The message preferably indicates when the “priority” television event being viewed by the user ends. Note that the ending time of the television event was saved by the processor 212 in step 608 of process 600. The processor 212 may play, for example, a message, “We are unable to come to the phone. You can either leave a message or call back at 10:00.” (where 10:00 is the time that the selected television event ends). The process 800 then proceeds to step 809, and the processor 212 records the calling party's telephone message as described below.

If the DND flag has not been set, in step 806 the processor 212 determines via the modem 210 if the number of rings on the first telephone line 110 (or from the room phone 112) exceeds a predetermined number of rings. The user of the novel television system 100 preferably sets the predetermined number of rings. If the number of rings does not exceed the predetermined number of rings, the process 800 returns to step 802; otherwise, the process 800 proceeds to step 807.

In step 807, the processor 212 answers the telephone call, and in step 808, the processor 212 plays a greeting to the calling party. The processor 212 may play any greeting specified by the user, or a default greeting provided by the set top box 102. For example, the processor 212 may play, “We are unable to come to the phone. Please leave a message.” The process 800 thereafter proceeds with step 809.

In step 809, the processor 212 records the telephone message from the calling party (e.g., in the memory 204), and allows the calling party to designate the telephone message as a “priority” message. As described further below, designating a telephone message a “priority” message preferably ensures that the telephone message will be reviewed by a user of the novel television system 100. The calling party may employ various methods to designate a message a priority message. Such methods may include dialing a predetermined number sequence (e.g., set by the user), dialing a numeric or alphanumeric code, etc.

In step 810, the processor 212 determines if the calling party designated the message as a priority message. If the calling party designated the telephone message as a priority message, in step 811, the processor 212 marks the telephone message as a priority message. The marked priority message is saved in the memory 204 in step 812. If the calling party did not designate the message as a priority message, the message is also saved in the memory 204 in step 812 but is not marked as a priority message In step 813, if the saved telephone message has not been marked by the processor 212 as a priority message, the process 800 repeats itself, starting with step 801. Otherwise, if the saved telephone message was marked by the processor 212 as a priority message, the process 800 proceeds with step 814. In step 814, the processor 212 determines if the novel set top box 102 is in use (e.g., is being employed to view a television event). If the set top box is not in use, the process 800 repeats itself, starting with step 801. However, if the set top box is in use, the process 800 proceeds with step 815. In step 815, the processor 212 disables the television set 116 by invoking process 900 described below with reference to FIG. 9.

FIG. 9 is a flowchart of a process 900 for disabling the television set 116 from displaying television events until the priority message recorded in process 800 of FIG. 8 has been reviewed. With reference to FIG. 9, the process 900 begins with step 901. If the television set 116 has been disabled by the process 900 (described below), in step 903, the process 900 ends. Otherwise, in step 904, the processor 212 determines if any priority messages exist, that have not been reviewed by the user. If the processor 212 determines that there are no unreviewed priority messages, the process 900 ends in step 905. Otherwise, if the processor 212 determines that there are unreviewed priority messages, the process 900 proceeds with step 906.

In step 906, the processor 212 disables the television set 116 from displaying television events (e.g., by disabling the television amplifier 208). In step 907, the processor 212 displays an indicator that there is at least one unreviewed priority message stored by the set top box 102. For example, the indicator may be a message on the television set 116 stating that one or more priority messages have not been reviewed. The indicator preferably prompts the user to press a button on the remote 120 to hear any priority messages.

In step 908, the processor 212 waits for the user to press a button to hear any priority messages. Once the user presses the required button, in step 909, the processor 212 broadcasts any unreviewed priority messages over a speaker of television set 116. Alternatively, the processor 212 can display priority messages (or an indicator that priority messages have been received) on the screen of the television 116 without disabling the television 116 (e.g., so as not to disturb a user watching a television event, particularly a priority television event). Caller ID information may be similarly displayed on the screen of the television 116. In step 910, after all unreviewed priority messages have been reviewed, the processor 212 re-enables the television set 116, allowing the television set 116 to display television events. In step 911, the process 900 ends.

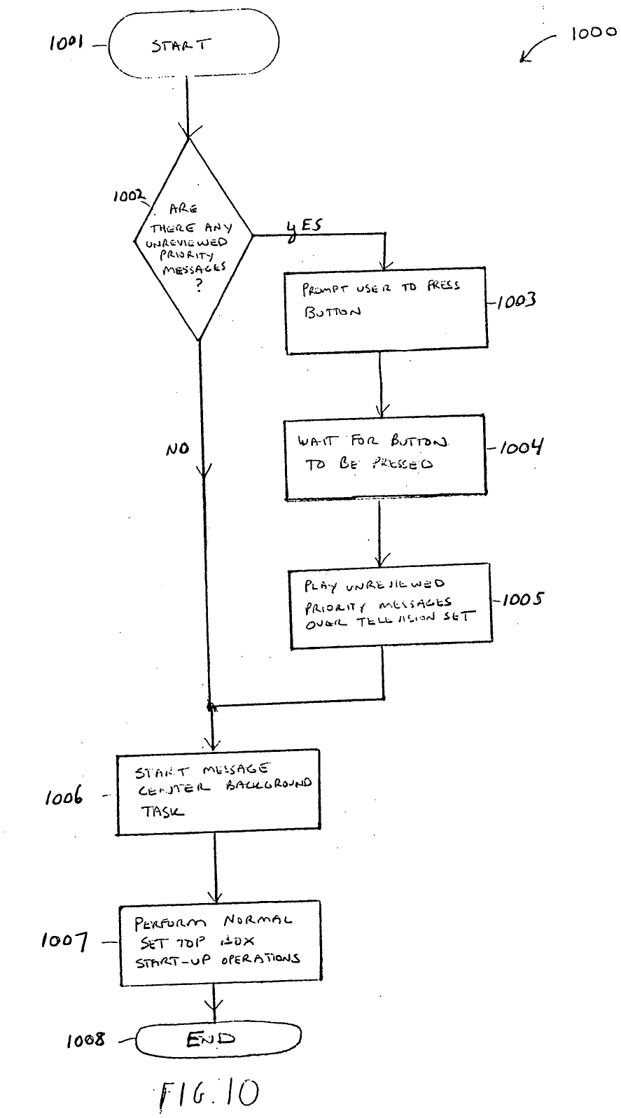

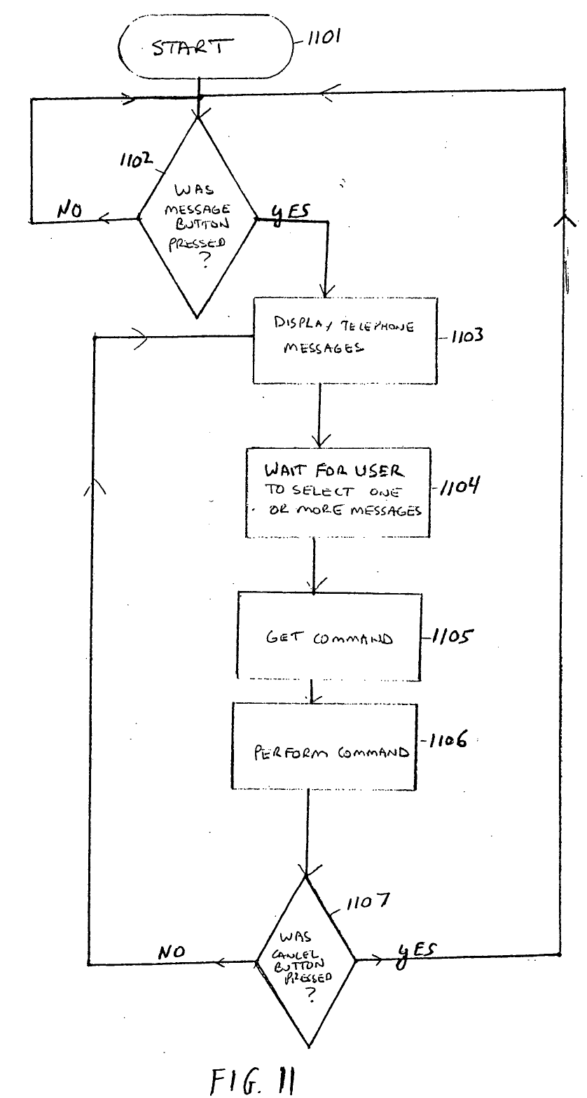

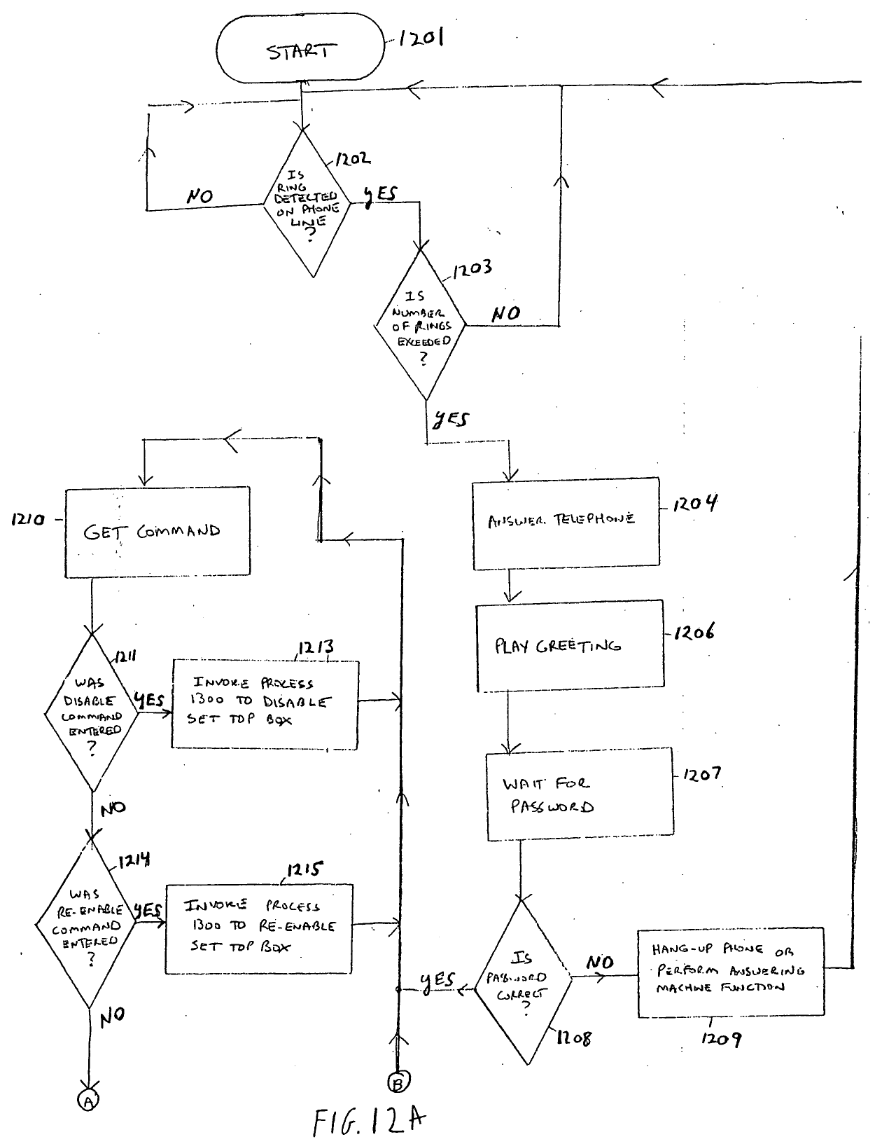

FIG. 10 is a flowchart of a process 1000 for disabling the television set 116 from displaying television events when the novel set top box 102 is powered on and unreviewed priority messages are stored by the set top box 102. With reference to FIG. 10, the process 1000 begins with step 1001. In step 1002, the processor 212 determines if there are any unreviewed priority messages stored within the set top box 102. If there are one or more unreviewed priority messages, the process 1000 proceeds with steps 1003-1005; otherwise the process 1000 proceeds with step 1006.

In step 1003, the processor 212 displays an indicator of the one or more stored priority messages. For example, the processor 212 may display a message on the television set 116 stating that one or more priority messages have been received. Preferably the indicator prompts the user to press a button on the remote 120 in order to hear the one or more priority messages.

In step 1004, the processor 212 waits for the user to press a button on the remote 120. After the user presses the button, in step 1005, the processor 212 broadcasts the one or more unreviewed priority messages over a speaker of the television set 116. Alternatively, the one or more priority messages may be displayed on the screen of the television set 116.

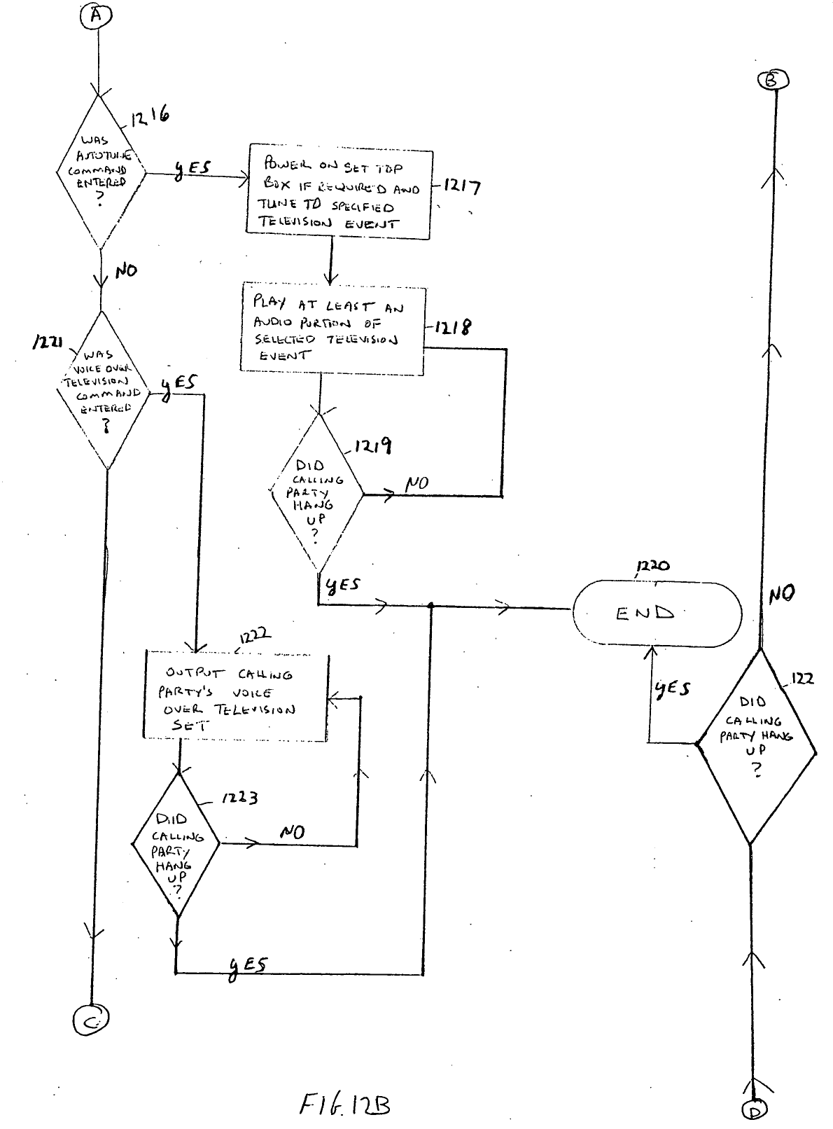

In step 1006, the processor 212 starts a message center background task as described below in FIG. 11. In step 1007, the novel set top box 102 performs its normal set top box start-up operations (e.g., retrieve last viewed channel, tune to last viewed channel, etc.). The process 1000 ends in step 1008.

FIG. 11 is a flowchart of a process 1100 that provides a menu of user selectable options for selecting, listening to, and deleting telephone messages with the novel set top box 102. With reference to FIG. 11, the process 1100 begins with step 1101. In step 1102, the processor 212 detects whether a message button was pressed by the user (e.g., a message button on the remote 120). If the message button has not been pressed by the user, the processor 212 continues to monitor whether the message button was pressed (step 1102). If the user presses the message button, in step 1103, the processor 212 displays any telephone messages (stored by the set box 102) on the screen of the television set 116.

In step 1104, the processor 212 waits for the user to select one or more of the displayed messages. Once one or more messages are selected, in step 1105, the processor 212 waits for a message command from the user. For example, play, rewind, fast forward and delete buttons may be provided on the remote 120 that allow selected telephone messages to be played, replayed, scanned rapidly and/or deleted. Alternatively, an on-screen menu option (not shown) may provide similar features. A user preferably also may change the number of rings required for the set top box 102 to answer, or change the greeting played by the set top box 102 in response to a telephone call. Preferably the user can alter the number of rings or the greeting without selecting a telephone message in step 1104. In step 1106, the processor 212 performs the command that was selected in step 1105. Thereafter, in step 1107, the processor 212 determines if the user pressed a “cancel” button on the remote 120. If the cancel button was pressed, the process 1100 repeats starting with step 1102. If the cancel button was not pressed, the process 1100 proceeds to step 1103.

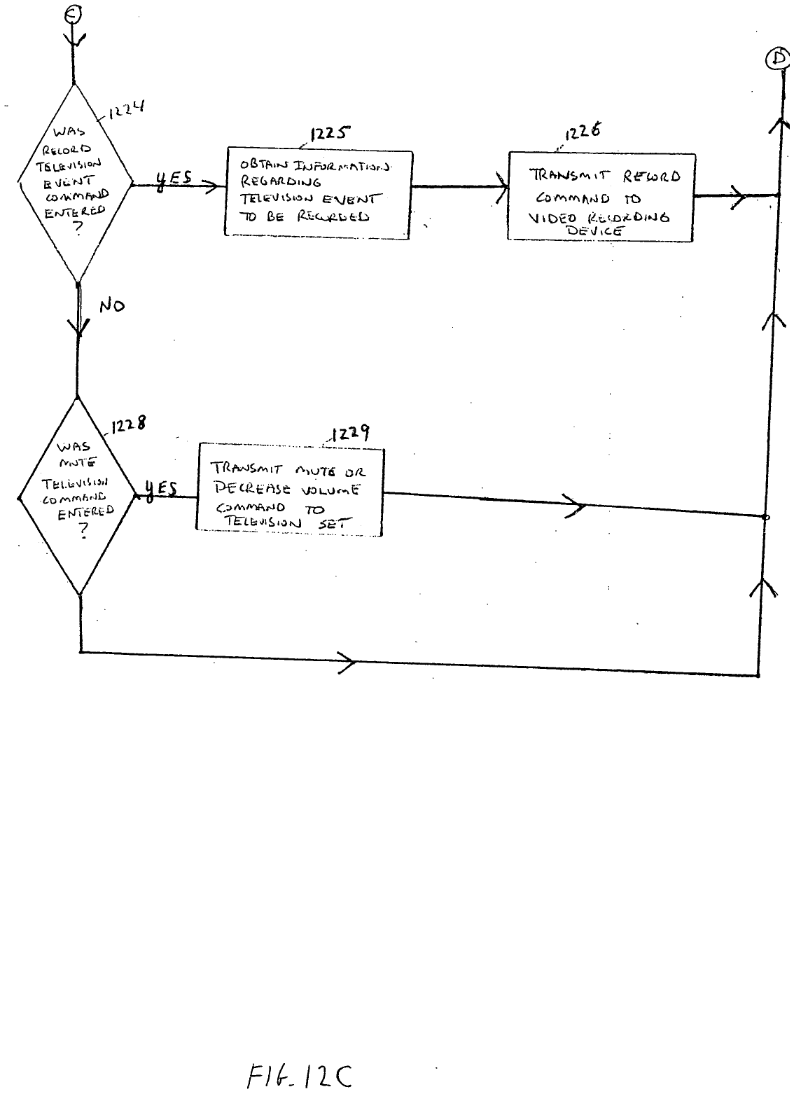

FIG. 12 is a flow chart of a process 1200 for controlling the novel set top box 102 via the phone line 110. The process 1200 begins in step 1201. In step 1202, the processor 212 monitors the phone line 110 via the modem 210 to determine if the room phone 112 is ringing (e.g., to determine if a call is present on the phone line 110). If no call is present on the phone line 110, the processor 212 continues to monitor the phone line 110 in step 1202; otherwise, the process 1200 proceeds to step 1203.

In step 1203, the processor 212 determines if the telephone call on the phone line 110 has rung more than a predetermined number of times (e.g., 2, 3, 4, etc., preferably a user-specifiable number). If the phone line 110 has not rung more than the predetermined number of times, the process 1200 returns to step 1202 and the processor 212 continues to monitor the phone line 110; otherwise, if the phone line 110 has rung more than the predetermined number of times, the process 1200 proceeds to step 1204.

In step 1204, the processor 212 (via the modem 210) “answers” the phone line 110 and plays a greeting to the calling party (step 1206). In step 1207, the processor 212 waits for a password to be entered by the calling party (e.g., a number or a sequence of numbers), and, in step 1208, the processor 212 determines if the password entered by the calling party is correct. If the password entered by the calling party is incorrect, in step 1209, the processor 212 either hangs up the phone line 110 or performs one of the answering machine functions of the novel set top box 102 described previously with reference to FIGS. 7-11.

If the password entered by the calling party is correct, in step 1210, the processor 212 waits for a command to be entered by the calling party. For example, the calling party may enter (dial) a pre-determined sequence of numbers for each command (e.g., set by the owner of the set top box 102). Thereafter the processor 212 may identify and perform the entered command. Specifically, in step 1211, the processor 212 determines if the calling party entered a “disable” command, and if so, the process 1200 proceeds with step 1213; otherwise, the process 1200 proceeds with step 1214.

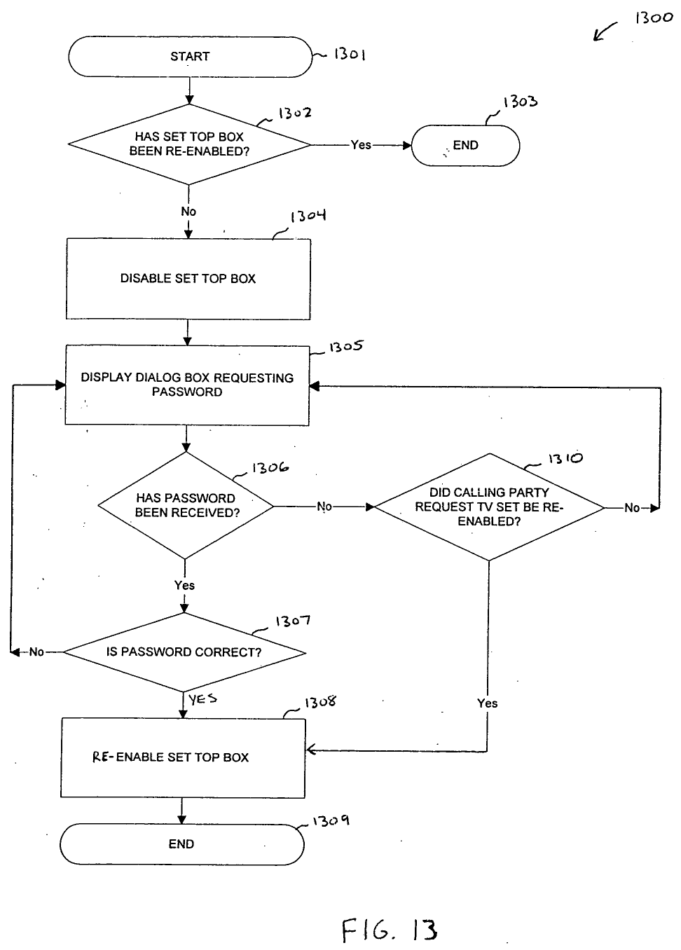

In step 1213, having determined that a “disable” command was entered by the calling party, the processor 212 invokes process 1300 to disable the novel set top box 102 as described below with reference to FIG. 13. For example, assume a child is at home watching a television program on the television set 116 when the child's parent calls the child via the phone line 110 (e.g., to ensure that the child has taken out the trash). If the parent does not receive the child's “undivided attention” due to the child's pre-occupation with the television program, the parent may disable the set top box via step 1213 (and process 1300 described below). Following step 1213, the process 1200 returns to step 1210 to receive another command from the calling party.

If in step 1211 the processor 212 determines that a disable command was not entered by the calling party, the processor 212 determines if the calling party entered a “re-enable” command (step 1214). If so, the process 1200 proceeds with step 1215; otherwise, the process 1200 proceeds with step 1216.

In step 1215, having determined that a “re-enable” command was entered by the calling party, the processor 212 invokes process 1300 to re-enable the novel set top box 102 as described below with reference to FIG. 13. For example, assuming the above described parent has obtained the child's “undivided attention” by disabling the novel set top box 102, has communicated the parent's desire to have the trash taken out, and has received the child's assurance that the trash will be taken out, the parent may re-enable the set top box 102 via step 1215 (and process 1300 as described below). Following step 1215, the process 1200 returns to step 1210 to receive another command from the calling party.

If in step 1214 the processor 212 determines that a re-enable command was not entered by the calling party, the processor 212 determines if the calling party entered an “autotune” command (step 1216). If so, the process 1200 proceeds with steps 1217-1220; otherwise, the process 1200 proceeds with step 1221.

In step 1217, having determined that an “autotune” command was entered by the calling party, the processor 212 powers on the novel set top box 102 if required (e.g., turns on any portion of the novel set top box 102 required for tuning the novel set top box 102 to a particular channel or television event), and tunes the novel set top box 102 to a television event specified by the calling party (preferably the set top box 102 is not in use by another party during this time). The calling party may specify a television event by entering the number of a particular channel, by one or more prompts or menus provided via the novel set top box 102, or by any other technique. Thereafter, in step 1218, the processor 212 plays at least an audio portion of the selected television event over the phone line 110 to the calling party. For example, if a person who is at work wishes to hear the weather report on channel 112 at noon, the person may call the set top box 102, change the channel to 112 (provided the set top box 102 is not in use), and listen to the weather report over the telephone line 110. The above process may be as simple as calling the set top box 102 and dialing #60 #112, where #60 is the set top box 102's command for listening to a channel. The processor 212 continues to play the selected television event over the phone line 110 until the processor 212 determines (via the modem 210) that the calling party has hung up (step 1219). If the processor 212 determines that the calling party has hung up, the process 1200 ends in step 1220. Note that the process 1200 may be modified to allow a calling party to enter a command that halts the playing of a television event over the phone line 110, and allows the calling party to enter another command in step 1210. The autotune feature may also be used as a simple remote control in homes that have multiple telephone lines (e.g., when the set top box 102 feeds multiple television sets).

If in step 1216 the processor 212 determines that an autotune command was not entered by the calling party, the processor 212 determines if the calling party entered a “voice over television” command (step 1221). If so, the process 1200 proceeds with steps 1222-1223; otherwise, the process 1200 proceeds with step 1224.

In step 1222, having determined that a “voice over television” command was entered by the calling party, the processor 212 disables any audio of a television event being output by the novel set top box 102 to the television set 116, and transmits an audio signal from the phone line 110 to the television set 116 (e.g., the calling party's voice is output over a speaker of the television set 116). This may be performed by routing the phone line 110's audio to the television set 116 via the television amplifier 208 (rather than the presently selected television event's audio). The voice over television command may be used, for example, by the above-described parent as an alternative to disabling the novel set top box 102 (step 1213). The processor 212 continues to transmit the audio signal from the phone line 110 to the television set 116 until the processor 212 determines (via the modem 210) that the calling party has hung up (step 1223). If the processor 212 determines that the calling party has hung-up, the process 1200 ends in step 1220. Note that the process 1200 may be modified to allow a calling party to enter a command that halts the transmission of the audio signal from the phone line 110 to the television set 116, and allows the calling party to enter another command in step 1210.

If in step 1221 the processor 212 determines that a voice over television command was not entered by the calling party, the processor 212 determines if the calling party entered a “record television event” command (step 1224). If so, the process 1200 proceeds with steps 1225-1227; otherwise, the process 1200 proceeds with step 1228.

In step 1225, having determined that a “record television event” command was entered by the calling party, the processor 212 obtains from the calling party information regarding the television event to be recorded (e.g., the channel of the television event, the time the television event starts, etc.). The calling party may specify television event information by entering the number of a particular channel and/or a television event time, by one or more prompts or menus provided via the novel set top box 102, or by any other technique. Thereafter, in step 1226, the processor 212 transmits a record command to a video recording device 122 (FIG. 1) coupled to the television set 116, indicating the television event and start time for recording. Alternatively, the novel set top box 102 itself may monitor the start time of the selected television event, and simply transmit a record command to the video recording device 122 when the television event begins. For example, the processor 212 may transmit the record command via an infrared diode 124 (FIG. 1) of the novel set top box 102.

In step 1227, the processor 212 determines if the calling party has hung up. If so, the process 1200 ends in step 1220; otherwise, the process 1200 returns to step 1210 to receive another command from the calling party.

If in step 1224 the processor 212 determines that a record television event command was not entered by the calling party, the processor 212 determines if the calling party entered a “mute television” command (step 1228). If so, the process 1200 proceeds with step 1229; otherwise, the process 1200 proceeds with step 1227 to determine if the calling party has hung up as previously described.

In step 1229, having determined that a “mute television” command was entered by the calling party, the processor 212 mutes the television set 116. The processor 212 may mute the television set 116 by disabling the television amplifier 208, or by transmitting a mute or decrease volume command to the television set 116 via the infrared diode 124. Again, the calling party (e.g., a parent) may wish to mute the television set during a conversation with a party viewing a television event (e.g., a child viewing a television event). Following step 1229, the process 1200 proceeds with step 1227 to determine if the calling party has hung up as previously described.

FIG. 13 is a flowchart of a process 1300 for disabling and enabling the novel set top box 102 in conjunction with the process 1200 of FIG. 12. With reference to FIGS. 12 and 13, after the processor 212 determines that the calling party has entered a disable command in step 1211 (FIG. 12), in step 1213 the process 1200 proceeds to step 1301 (FIG. 13) wherein the process 1300 begins.

In step 1302, the processor 212 determines if the novel set top box 102 was re-enabled in step 1215 of process 1200, and if so, the process 1300 ends in step 1303; otherwise, the process 1300 proceeds with step 1304 wherein the processor 212 disables the novel set top box 102 (e.g., no longer allows the set top box 102 to play television events over the television set 116).

Once the novel set top box 102 is disabled, a user of the novel set top box 102 preferably may only view television events over the television set 116 if either (1) the calling party re-enables the novel set top box 102 (e.g., via a re-enable command in step 1215 of process 1200 as described below); or (2) the user of the novel set top box 102 enters a password that re-enables the novel set top box 102. Any other method for re-enabling the novel set top box 102 may be employed.

In accordance with the preferred embodiment, in step 1305, the processor 212 prompts a user of the novel set top box 102 for a password that, if entered correctly, will re-enable the novel set top box 102. Preferably the processor 212 displays a dialog box on the television set 116 that requests entry (e.g., via the remote control 120) of a password. In step 1306, the processor 212 waits a pre-determined time period for the user to enter a password. If the user enters a password within the pre-determined time period, the process 1300 proceeds with steps 1307-1309; otherwise, the process 1300 proceeds with step 1310.

If the user entered a password within the pre-determined time period, in step 1307 the processor 212 determines if the password entered by the user is correct. If the entered password is correct, in step 1308 the novel set top box 102 is re-enabled (e.g., a television event once again may be viewed via the television set 116) and the process 1300 ends in step 1309; otherwise, if the password is incorrect, the process 1300 returns to step 1305 to re-prompt the user for a password.

If the user failed to enter a password in step 1306, in step 1310 the processor 212 determines if a calling party requested (in step 1215 of process 1200) that the novel set top box 102 be re-enabled. If a calling party requested that the novel set top box 102 be re-enabled, the novel set top box 102 is re-enabled (step 1308) and the process 1300 ends (step 1309); otherwise, if a calling party did not request that the novel set top box 102 be re-enabled, the process 1300 returns to step 1305 to re-prompt the user for a password.

The foregoing description discloses only the preferred embodiments of the invention, modifications of the above disclosed apparatus and method which fall within the scope of the invention will be readily apparent to those of ordinary skill in the art. For instance, the particular methods and/or apparatus disclosed herein for receiving commands from users of the novel set top box 102 and/or calling parties are merely preferred, and any other methods and/or apparatus may be similarly employed. Other set top box features also may be provided. The novel set top box may be programmed to, for example, automatically mute the television set 116 and/or pause the video recording device 122 if the room phone 112 is picked up (e.g., via a command sent from the modem 210 to the processor 212). Preferably the video recording device 122 is not paused if the video recording device 122 is recording a television event. Also, a calling party preferably can retrieve messages stored by the novel set top box from a remote telephone. Any other counter may be used in place of count down counter (e.g., a “count up” counter).

Accordingly, while the present invention has been disclosed in connection with the preferred embodiments thereof, it should be understood that other embodiments may fall within the spirit and scope of the invention, as defined by the following claims.

The invention claimed is:

1. A method of controlling a set top box comprising:
providing a set top box that can be controlled by a telephone line coupled to the set top box;
receiving a telephone call from a calling party via the telephone line; and
controlling the set top box via at least one command transmitted by the calling party to the set top box during the telephone call.

2. The method of claim 1 wherein controlling the set top box via at least one command transmitted by the calling party comprises receiving at least one predetermined number dialed by the calling party.

3. The method of claim 1 wherein controlling the set top box comprises disabling the set top box.

4. The method of claim 1 wherein controlling the set top box comprises enabling the set top box.

5. The method of claim 1 wherein controlling the set top box comprises directing the set top box to decrease a volume of a television set coupled to the set top box.

6. The method of claim 5 further comprising directing the set top box to transmit an audio signal from the calling party over a speaker of the television set.

7. The method of claim 1 wherein controlling the set top box comprises directing the set top box to play at least an audio portion of a television event over the telephone line.

8. The method of claim 1 wherein controlling the set top box comprises directing the set top box to tune to a television event.

9. The method of claim 1 wherein controlling the set top box comprises directing the set top box to record a television event.

10. The method of claim 9 wherein directing the set top box to record a television event comprises directing the set top box to transmit a record command to a video recording device.

11. The method of claim 1 wherein controlling the set top box comprises directing the set top box to play a telephone message previously recorded by the set top box.

12. An apparatus adapted to employ a telephone interface comprising:
a processor comprising computer program code adapted to control a set top box via at least one command transmitted by a calling party over a telephone line coupled to the set top box, the command being transmitted during a telephone call.

13. A set top box comprising the apparatus of claim 12.

14. A computer program product for controlling a set top box comprising:
a medium readable by a computer, the computer readable medium having means for controlling a set top box via at least one command transmitted by a calling party over a telephone line coupled to the set top box, the command being transmitted during a telephone call.
